(19) United States
(12) Patent Application Publication
(10) Pub. No.: US 2009/0119707 A1
(43) Pub. Date: May 7, 2009

(54) AUTOMATIC CHANNEL SEARCH METHOD AND SYSTEM THEREOF

(75) Inventor: Guojie ZHAO, Shenzhen (CN)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SHENZHEN HUAQIANG SANYO TECHNOLOGY DESIGN CO., LTD., Shenzhen (CN)

(21) Appl. No.: 12/262,914

(22) Filed: Oct. 31, 2008

(30) Foreign Application Priority Data
Nov. 1, 2007 (CN) 200710165763.1

(51) Int. Cl. H04N 5/445

(52) U.S. Cl. 725/38

(57) ABSTRACT

An automatic channel search system for use with a video display apparatus that has multiple video interfaces, in which all the channels of the multiple video interfaces are searched for a signaling channel carrying thereon a signal, and the signaling status and/or non-signaling status the respective channels is recorded. Utilizing this method, a channel search operation can be achieved in a significantly reduced time. Particularly, when there is one only one signaling channel found in the search, straightforward image processing is performed on the signal carried on that signaling channel to display the image of the signal. Further, when more than one signaling channel is found, the signaling channels are shown for the user to select one, and the signal of the selected channel is processed and displayed.

### FIELD OF THE INVENTION

This invention relates to a method of searching channels in an automatic fashion (the method hereinafter referred to as automatic channel search method) for use with a video display apparatus having multiple video interfaces. The invention also relates to a system utilizing such method.

### BACKGROUND OF THE INVENTION

Video display apparatuses available in the market are equipped with means for displaying the contents of inputted signals as shown in FIG. 1.

In the apparatus shown in FIG. 1, a signal is inputted from a video interface 10 to a signal processing module 20, where the signal is subjected to a signal format conversion and decoding. After being decoded, the signal is fed to a scaler gamma 30 for image processing. The resultant signal thus processed is displayed on a display device 40.

Thanks to continuous improvement in image processing technology, video interfaces are constantly evolving. Presently, the video interface 10 includes, for example, a COMPOSITE, COMPONENT, S-VIDEO, D-SUB, VGA, DVI, HDMI, and USB interface.

Present display apparatuses are mostly provided with some or all of the above-mentioned interfaces in order to allow a user to receive signals of different formats. It is true that implementation of many interfaces can provide the user with a variety of selective signals. At the same time, however, unless the user are familiar with the interfaces, he will be only puzzled with the multitude of the interfaces, without knowing what to do with them.

To assist such user with this problem, the display apparatus may be provided with an automatic channel search function (referred to as auto-search function) for detecting a signal carried on a signaling channel providing a video signal. In the present auto search function, upon enablement of the function by the user by choice, the CPU of the display apparatus automatically starts searching the video interface 10 for a video signal. For example, the CPU first searches an RGB channel for an RGB signal and displays the content of the signal if it is detected. If no RGB signal is found, the CPU searches the component channel for a signal, and, upon detection of a component signal, displays the content of the signal. If no signal is found, the CPU proceeds to search the DVI channel. In this way, the channel search is continued until a signal is found in any of the channels. For more details, refer to FIG. 8 showing a sequence of exemplary images displayed on the screen of the display device and FIG. 9 showing a flowchart of the search procedure.

However, such a conventional search scheme as stated above has two problems as discussed below. Firstly, it takes a long search time. Under the present technological limitations, any image processing requires an appreciable time. For example, in the channel search procedure as shown in a flowchart of FIG. 9, image processing must be performed at least once for each of the channels involved regardless of the signaling status of each channel carrying a signal or not. Thus, image processing is performed even for a channel exhibiting a blue screen that manifests “no signal” carried on the channel. The more video interfaces exist in a display apparatus, the more signal channels exist that require signal search, and accordingly a longer search time is needed, since each image processing time in the search accumulates. Secondly, the signal displayed is not necessarily the one needed by the user. As mentioned above, the display apparatus is not usually dedicated to a single interface. Therefore, it may happen that signals are simultaneously inputted to more than one interface. As shown in the flowchart of FIG. 9, channels are searched in order of priority assigned thereto. Thus, under such priority condition, the signal that the user obtains in the search is not necessarily the one he actually needs. For example, suppose that the display apparatus has received an RGB signal and an S-VIDEO signal. But since the RGB signal has a higher search priority than the S-VIDEO signal, the RGB signal is displayed, though in actuality the user needs the S-VIDEO signal.

### SUMMARY OF THE INVENTION

In order to solve such prior art problems, the present invention is directed to an automatic channel search method that enables significant reduction of channel search time of a video display apparatus having multiple video channels. The invention is also directed to a system utilizing such method

In order to achieve the above objects, the invention provides an automatic channel search method for use with a video display apparatus having multiple video interfaces, the method comprising steps of:

detecting a signaling channel carrying thereon a signal by searching all of the channels of the video interfaces; and

recording signaling status and/or non-signaling status of the respective channels.

Thus, in a channel search operation, it suffices to perform signal detection procedure only once for every channel without performing image processing for the respective channels. Since this signal detection procedure involves only a simple determination as to whether a channel carries thereon a signal or not, it requires only several dozen milliseconds, in contrast to several hundreds milliseconds required in the prior art. Thus, as compared with the conventional method, this invention can significantly reduce the channel search time.

As a further improvement achieved by the invention, the degree of progress of a channel search operation may be displayed during the operation. This helps the user actually grasp the degree of progress of the search operation.

As another improvement achieved by the invention, each of the channels is represented by a characteristic icon. Such icons greatly help the user to intuitively identify and select the channel of interest.

In addition,.straightforward image processing can be applied to a signaling channel to display the image on the channel if that channel is the only one signaling channel found. If there is more than one signaling channel found, the user may select a signaling channel for his preference. Image processing may be performed on the signal carried on the selected channel to display the image of the signal. Moreover, a channel selection menu may be displayed for the user selecting a signaling channel. This channel selection menu may distinguishably show the signaling and non-signaling channels. Specifically, the channel selection menu may display signaling channels in dark selectable forms and non-signaling channels in gray non-selectable forms. The entries in the channel selection menu and the associated video interfaces may be represented by the same icons. Thus, the user can intuitively and conveniently select the channel he likes,

An automatic channel search system of the invention comprises:

a detector for detecting a signaling channel carrying thereon a signal by searching all of the channels of the video interfaces; and

a recorder for recording signaling and/or non-signaling status of the respective channels.

In the inventive automatic channel search system, it suffices to execute a signal detection procedure just once for the respective channels in a search operation, without performing image processing for each of the channels. Thus, as compared with the prior art search methods, this invention can significantly reduce channel search time.

### BRIEF DESCRIPTION OF THE DRAWINGS

FIG. 1 is a basic block diagram of a video display apparatus.

FIG. 2 is a flowchart of a channel search operation of an automatic channel search method in accordance with one embodiment of the invention.

FIG. 8 is a flowchart of a channel search operation of an automatic channel search method in accordance with another embodiment of the invention.

FIG. 4 is a flowchart of a channel search operation of an automatic channel search method in accordance with a still another embodiment of the invention.

FIG. 5 is a figure showing an onscreen display (OSD) bar for indicating the degree of progress of a channel search operation in accordance with the invention.

FIG. 6 is a figure showing an OSD channel selection menu of the invention.

FIG. 7 shows a sequence of images shown on a display device in accordance with the automatic channel search method of the invention.

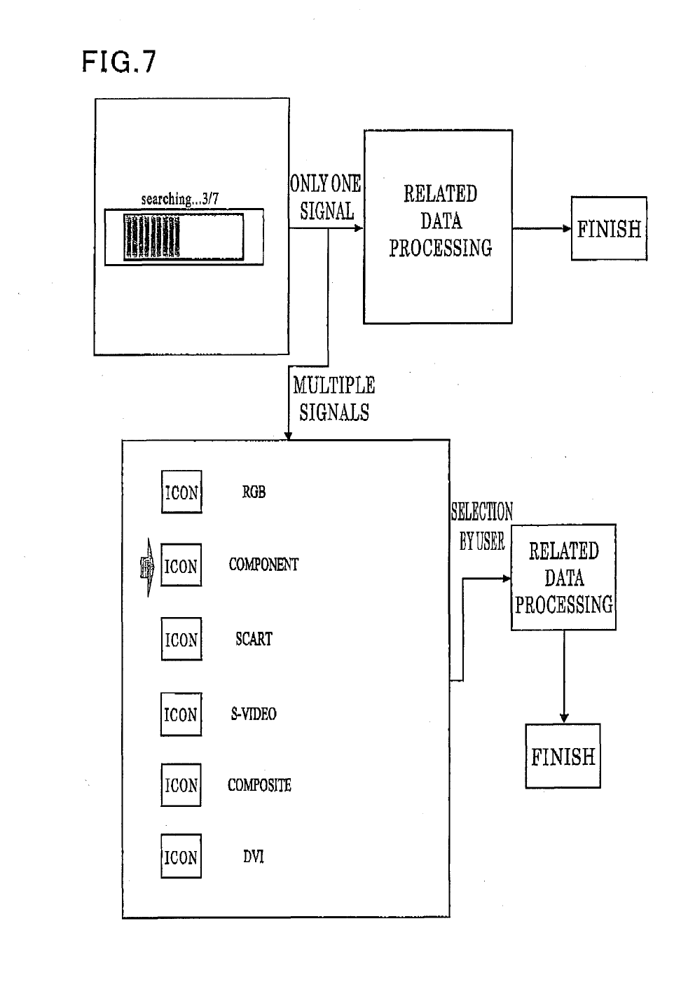

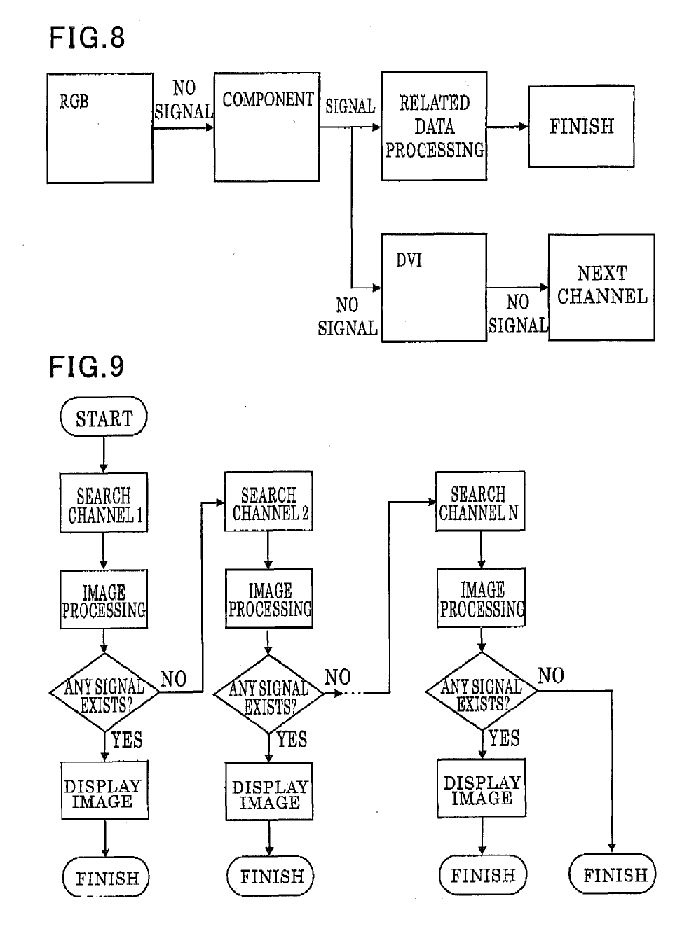

FIG. 8 shows a sequence of images shown on a display device in accordance with a prior art automatic channel search method.

FIG. 9 is a flowchart illustrating steps assumed in the prior art automatic channel search method.

### DETAILED DESCRIPTION OF THE PREFERRED EMBODIMENTS

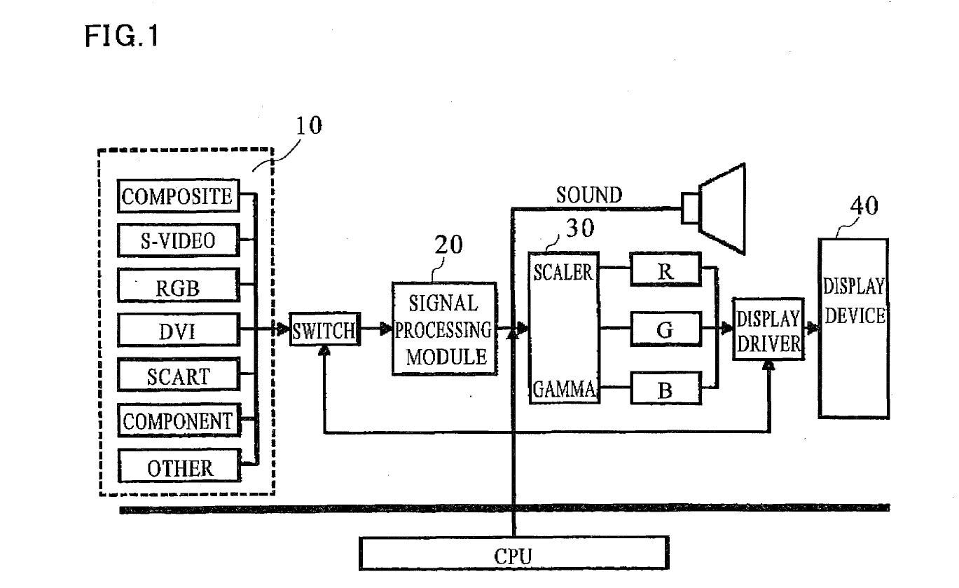

Referring to FIGS. 1, 8, and 9, there is shown a prior art automatic channel search method for use with a video display apparatuses having multiple video interfaces.

As shown in FIG. 1 and as discussed previously, a signal is fed from a video interface 10 to a signal processing module 20, where the signal is subjected to a signal format conversion and decoding, after which the signal is sent to a scaler gamma 30 for image processing. Upon completion of the image processing, the signal is displayed on a display device 40 of the video display apparatus.

FIG. 8 shows a sequence of images shown on a display device in accordance with the prior art automatic channel search method. In this example, an RGB channel is searched first for a signal. If the RGB channel is a non-signaling channel carrying no signal, then the component channel is searched. If the component channel is a signaling channel carrying a signal, the search operation is finished at this stage. If the component channel is a non-signaling channel, then the DVI channel is searched. In this way, the search operation is continued until a signaling channel is found.

FIG. 9 shows a flowchart illustrating steps assumed in the prior art automatic channel search method. It is seen in FIG. 9 that this channel search operation executes image processing for each of the channels at least once, regardless of the signaling status of the channel carrying or not carrying a signal. For example, a non-signaling channel exhibiting a blue screen, indicating that the channel carries “no signal”, must be still subjected to image processing.

Because of present technical limitations, image processing requires a certain processing time, so that a long channel search time is required for a video display apparatus having multiple video interfaces, since the channel search time accumulatively increases with the number of the signal channels to be searched, whereas the number of the signal channels increases with the number of the video interfaces.

It is seen in FIG. 9 that the channel search operation proceeds to the channels in sequence in order of predetermined priority. Under such condition, what the display apparatus obtains in the search operation for the user is not necessarily the signal needed by the user. For example, suppose that the display apparatus has presently received an RGB signal and an S-VIDEO signal, though in actuality the latter one is needed. However, since the RGB signal has a higher search priority over the S-VIDEO signal, what is displayed on the image screen of the display device is the RGB signal.

### EXAMPLE 1

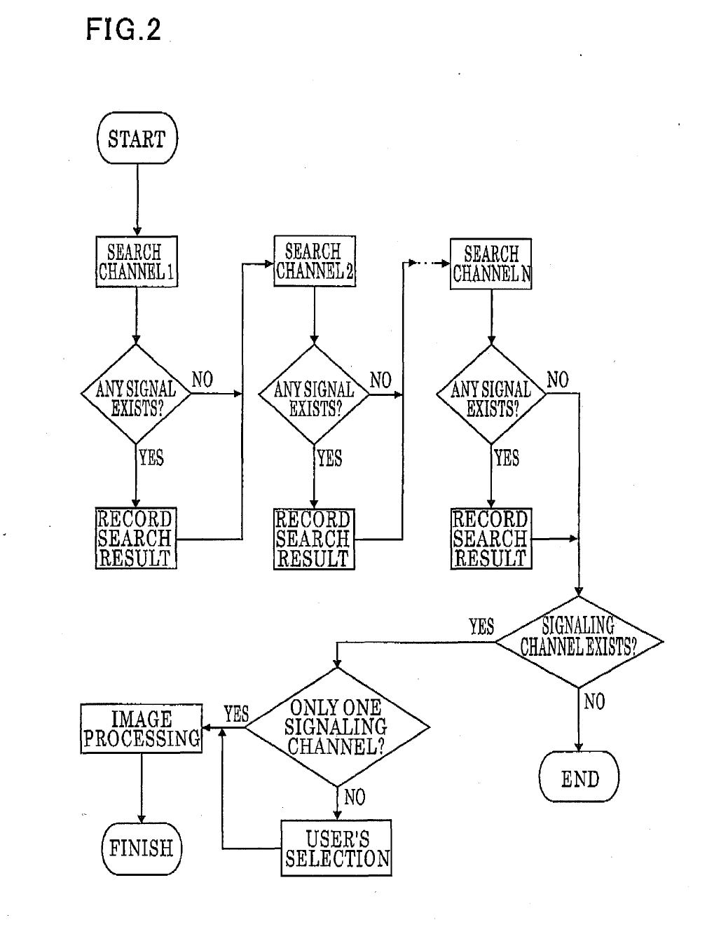

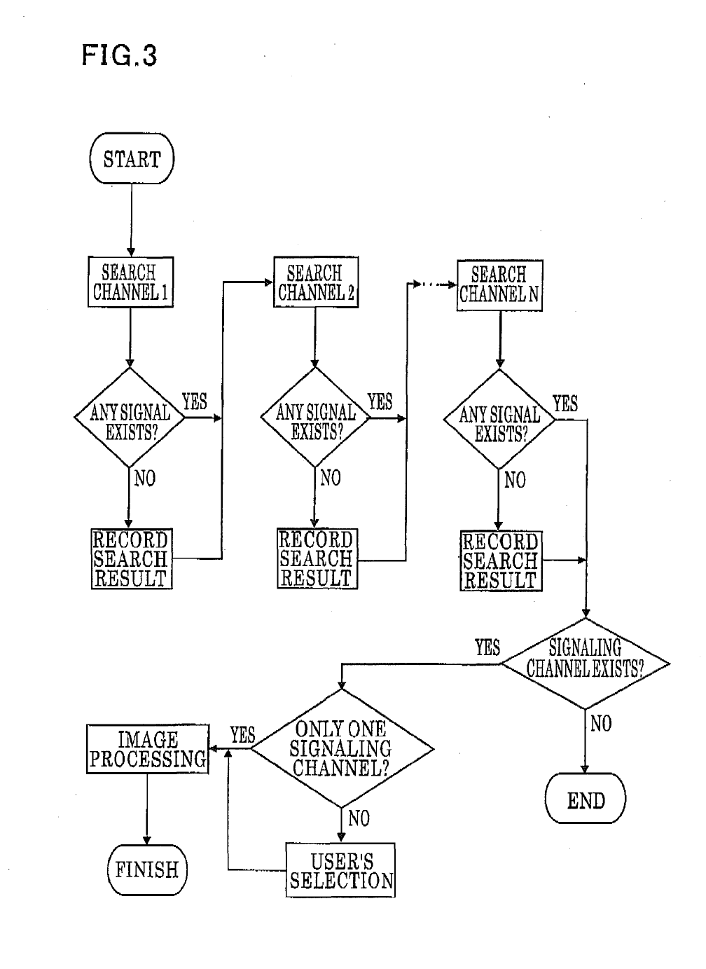

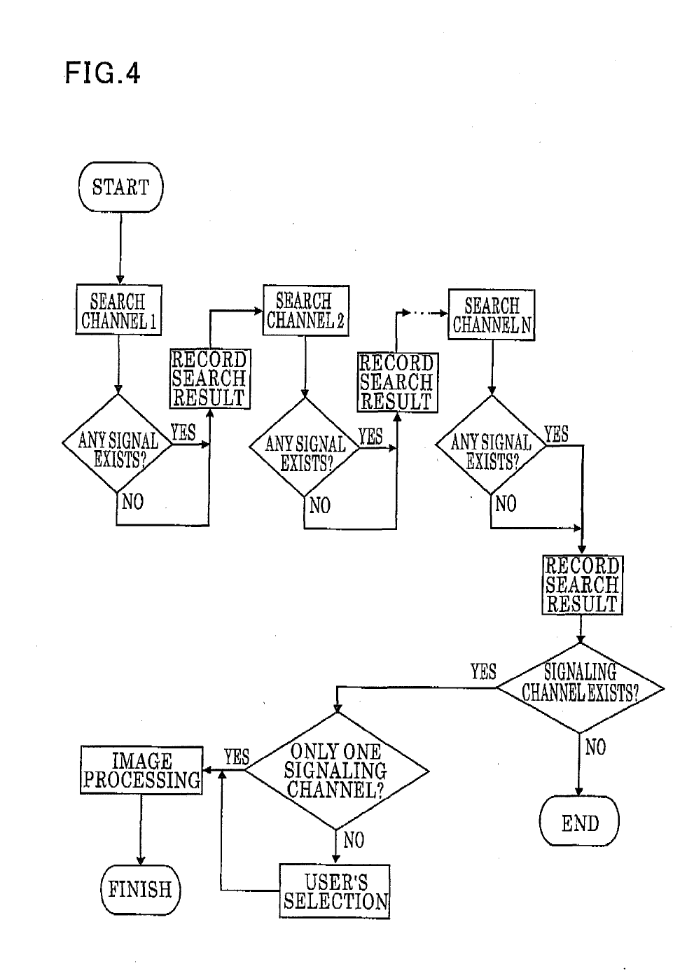

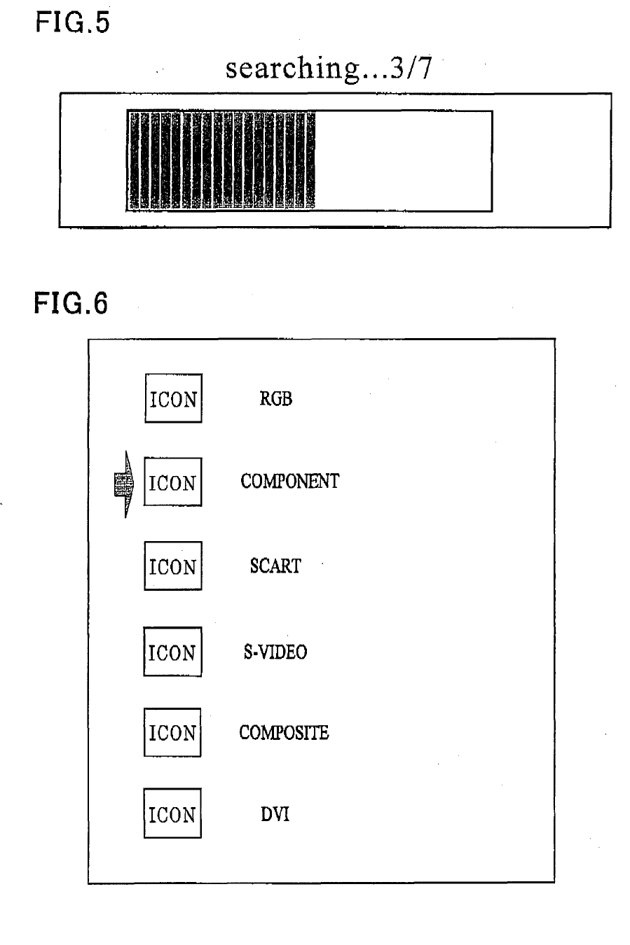

FIG. 2 is a flowchart of a signal detection operation assumed in the automatic channel search method in accordance with one embodiment of the invention.

The channel search operation starts with channel 1 as shown in FIG. 2. Thus, signal detection procedure is first conducted for channel 1. If this channel is a signaling channel, the result of the signal detection procedure is recorded.

Channel 2 is searched next. That is, the signal detection operation proceeds to channel 2 to conduct a signal detection procedure to search for a signal carried thereon. If channel 2 is a signaling channel carrying a signal, the result of the signal detection procedure is recorded, after which the search operation proceeds to the next channel.

If the video display apparatus has N channels, the search procedure is repeated N times. If channel N is a signaling channel, the result of the signal detection procedure is recorded.

Upon completion of the search operation for all of the N channels with no signaling channel, the search operation is ended.

If there is one and only one signaling channel found in the search operation, straightforward image processing is performed on the signal of that signaling channel to display the image obtained.

When there is more than one signaling channel found in the search operation, all the signaling channels are shown for the user as selectable channels. When he selects a preferred one, image processing is performed on the signal of the selected channel to display the image obtained.

### EXAMPLE 2

FIG. 3 is a flowchart of a signal detection operation assumed in the automatic channel search method in accordance with another embodiment of the invention.

The channel search operation is started with channel 1 as shown in FIG. 3. Thus, a signal detection procedure is first conducted on channel 1. If this channel is a non-signaling channel, the result of the signal detection procedure is recorded.

Channel 2 is searched next. That is, the signal detection operation proceeds to channel 2 to conduct a signal detection procedure to search for a signal carried thereon. If channel 2 is a non-signaling channel, the result of the signal detection procedure is recorded, after which the search operation proceeds to the next channel,

If the video display apparatus has N channels, the search procedure is repeated N times. If channel N is a non-signaling channel, the result of the signal detection procedure is recorded.

Upon completion of the search operation for all of the N channels with no signaling channel, the search operation is ended.

If there is one and only one signaling channel found in the search operation, straightforward image processing is performed on the signal of that signaling channel to display the image obtained.

When there is more than one signaling channel found in the search operation, all the signaling channels are shown for the user as selectable channels. When he selects a preferred one, image processing is performed on the signal of the selected channel to display the image obtained.

### EXAMPLE 3

FIG. 4 is a flowchart of a signal detection operation assumed in the automatic channel search method in accordance with a further embodiment of the invention.

The channel search operation is started with channel 1 as shown in FIG. 4. Thus, a signal detection procedure is first conducted for channel 1, and the result of the signal detection procedure is recorded regardless of whether this channel is a signaling channel or not.

Channel 2 is searched next. That is, the signal detection operation proceeds to channel 2 to conduct a signal detection procedure to search for a signal carried thereon, and the result of the signal detection procedure is recorded regardless of whether this channel is a signaling channel or not, after which the operation proceeds to the next channel.

If the video display apparatus has N channels, the search procedure is repeated N times. The result of the signal detection procedure for channel N is recorded regardless of whether this channel is a signaling channel or not.

Upon completion of the search operation for all of the N channels with no signaling channel, the search operation is ended.

If there is one and only one signaling channel found in the search operation, straightforward image processing is performed on the signal of that signaling channel to display the image obtained.

When there is more than one signaling channel found in the search operation, all the signaling channels are shown for the user as selectable channels. When he selects a preferred one, image processing is performed on the signal of the selected channel to display the image obtained.

In any of the channel search methods described above, the degree of progress of a channel search operation can be displayed on an OSD type progress bar as shown in FIG. 5. The degree of progress can be shown in any other alternative form.

When more than one signaling channel is found at the end of the search operation for all the channels, a channel selection menu is displayed for the user to select a preferred signaling channel. The channel selection menu can be an OSD menu as shown in FIG. 6, or can be of any other form convenient for the user.

The channel selection menu of FIG. 6 displays signaling and non-signaling channels in distinguishable forms. For example, the channel selection menu can display signaling channels in dark selectable forms and non-signaling channels in gray non-selectable forms. Signaling and non-signaling channels can be displayed in other forms. The icons of the channels in the channel selection menu can be the same as the icons of associated video interfaces.

Referring to FIG. 7, there is shown a sequence of images shown on the display device in the automatic channel search method of the invention.

During a channel search operation of the invention, what is shown on the image screen is the OSD progress bar shown in FIG. 5. When there is one and only one signaling channel found at the end of a search operation, the image of that channel appears on the image screen.

However, if there is more than one signaling channels found, an OSD channel selection menu as shown in FIG. 6 is displayed on the screen for the user. This menu displays the signaling channels in dark selectable forms, and non-signaling channels in gray non-selectable forms.

Upon selection of a preferred signaling channel by the user, the image of that channel appears on the image screen, after which the channel search operation is finished.

An inventive automatic channel search system for use with a video display apparatus having multiple video interfaces has a detector for detecting a signaling channel carrying thereon a signal by searching all of the channels of the video interfaces, and a recorder for recording signaling status and/or non-signaling status of the respective channels.

The invention has been described and shown with reference to a few embodiments. However, it will be understood by a person of ordinary skill in the art that variations and modifications of the present invention can be effected without departing from the scope of the invention defined in the appended claims.

It will be also understood by a person skilled in the art that the invention is not limited for use in the selection of video channels, but can be applied to the selection of audio channels and related channels.

1. An automatic channel search method for use with a video display apparatus having multiple video interfaces, the method comprising steps of:
detecting a signaling channel carrying thereon a signal by searching all of the channels of the video interfaces; and
recording signaling status and/or non-signaling status of the respective channels.

2. The automatic channel search method according to claim 1, further comprising a step of displaying the degree of progress of the step of searching the channels.

3. The automatic channel search method according to claim 1 or claim 2, wherein each of the channels of the multiple video interfaces is represented by a characteristic icon.

4. The automatic channel search method according to claim 1, wherein
straightforward image processing is performed on the signal carried on a signaling channel to display the image of the signal if that channel is the only one signaling channel detected.

5. The automatic channel search method according to claim 1, wherein, if more than one signaling channel is found,
the signaling channels are made selectable for the user of the video display apparatus; and
image processing is performed on the signal carried on the signaling channel selected by the user to display the image of the signal.

6. The automatic channel search method according to claim 5, wherein a channel selection menu is displayed for the user to select one signaling channel.

7. The automatic channel search method according to claim 6, wherein the channel selection menu distinguishably shows signaling and non-signaling channels.

8. The automatic channel search method according to claim 7, wherein the channel selection menu displays signaling channels in dark selectable form and non-signaling channels in gray non-selectable form.

9. The automatic channel search method according to claim 6, wherein the channel selection entries of the channel selection menu are represented by the same icons as the associated video interfaces.

10. An automatic channel search system for use with a video display apparatus having multiple video interfaces, the automatic channel search system comprising:
a detector for detecting a signaling channel carrying thereon a signal by searching all of the channels of the video interface; and
a recorder for recording signaling status and/or non-signaling status of the respective channels.
